(19) United States
(12) Patent Application Publication
(10) Pub. No.: US 2026/0266212 A1
(43) Pub. Date: Sep. 10, 2026

(54) ENGINE SYSTEM EMPLOYING AIR JET INJECTION FOR LIMITING PLUME-PLUME INTERACTION OF COMBUSTING FUEL SPRAY PLUMES

(71) Applicant: Caterpillar Inc., Peoria, IL (US)

(72) Inventor: Russell P. Fitzgerald, Peoria, IL (US)

(73) Assignee: Caterpillar Inc., Peoria, IL (US)

(21) Appl. No.: 19/069,704

(22) Filed: Mar. 4, 2025

(51) Int. Cl. F02B 23/06

(52) U.S. Cl. CPC F02B 23/0618; F02B 19/14; F02B 23/0648

(57) ABSTRACT

An engine system includes an engine having a cylinder block and a fuel injector supported in the cylinder head and having a plurality of spray orifices defining a plurality of outgoing plume paths. The engine system also includes a pressurized air supply. The cylinder head includes a plurality of air ports distributed circumferentially around a fuel injector center axis, fluidly connected to the pressurized air supply and arranged offset from the outgoing plume paths to admit air jets into the cylinder for limiting interaction between combusting fuel spray plumes. Related methodology is also disclosed.

### TECHNICAL FIELD

The present disclosure relates generally to a direct injected engine system, and more particularly to admitting air jets into a cylinder for limiting interaction between combusting plumes of a fuel.

### BACKGROUND

Modern internal combustion engines include one or more cylinders each having an associated piston together forming a combustion chamber or cylinder. Fuel for combustion is admitted into the combustion chamber commonly by way of a fuel injector. Fuel injectors can be arranged as direct injectors directly injecting the fuel and extending into the combustion chamber, or as port-injectors or manifold-injectors, for example. Fuel injectors typically include several spray orifices, the opening and closing of which is controlled by way of a needle valve or similar component sometimes referred to as a check.

Depending upon fuel type, combustion of the fuel in the cylinder tends to produce a range of emissions in exhaust from the engine, some of which are considered undesirable. Many strategies are known for filtering, chemically reducing, or otherwise treating exhaust constituents to limit discharge in the exhaust. In recent years, there has been great interest in controlling and/or managing the manner and mechanisms of combustion in-cylinder in an effort to control the exhaust emissions profile of internal combustion engines so as to reduce or eliminate requirements for aftertreatment strategies.

One exhaust constituent long recognized as desirable to trap or mitigate is particulate matter, in particular soot. Engineers have long recognized that higher in-cylinder temperatures, among other factors, can result in reduced soot production. Higher temperatures often accompany increased production of oxides of nitrogen or “NOx,” which are also undesirable. Thus, various engine strategies seek to strike a balance between reduced soot production, on the one hand, without unduly increasing NOx on the other. Certain piston designs are known that seek to achieve these aims. Even where soot and NOx are optimally balanced, it can nevertheless be difficult to avoid engine efficiency penalties.

Other known strategies include ducted fuel injection assemblies including one or more tubular structures supported adjacent to the fuel injector and positioned such that the ducts receive fuel spray jets from the fuel injector. The fuel spray tends to interact with the ducts to ultimately enhance mixing of the fuel with air, in particular by increasing the so-called “liftoff” length of the fuel spray jets to increase mixing of air with the plumes of fuel. One known ducted fuel injection application is set forth in U.S. Pat. No. 11,885,290 B2 to John et al. While ducted injection, soot and NOx balancing technologies, and other strategies, have all shown promise, and some have seen commercial success, the art provides ample opportunity for improvements alternatives.

### SUMMARY

In one aspect, an engine system includes an engine having a cylinder block with a cylinder formed therein, and a cylinder head attached to the cylinder block. The engine system also includes a fuel injector defining a fuel injector center axis supported in the cylinder head and having a plurality of spray orifices formed therein and defining a plurality of outgoing spray plume paths, and a pressurized air supply. The cylinder head includes a plurality of air ports distributed circumferentially around the fuel injector center axis, fluidly connected to the pressurized air supply and arranged offset from the plurality of outgoing plume paths to admit air jets into the cylinder for limiting spray plume-spray plume interaction.

In another aspect, a method of operating an engine includes redirecting combusting spray plumes of a directly injected fuel upwardly in a cylinder in an engine, and injecting air jets into the cylinder at locations offset from the combusting spray plumes circumferentially around a center axis of a fuel injector. The method further includes impinging the air jets upon the combusting spray plumes so as to limit spray plume-spray plume interaction in the cylinder.

In still another aspect, a cylinder head assembly includes a cylinder head, and a fuel injector supported in the cylinder head defining a fuel injector center axis having a plurality of spray orifices formed therein and defining a plurality of outgoing spray plume paths. The cylinder head includes a plurality of air ports distributed circumferentially around the fuel injector center axis, and arranged offset from the plurality of outgoing spray plume paths to admit air jets into the cylinder for limiting spray plume-spray plume interaction.

### BRIEF DESCRIPTION OF DRAWINGS

FIG. 1 is a partially sectioned side diagrammatic view of an internal combustion engine system, according to one embodiment;

FIG. 2 is an elevational view of portions of an internal combustion engine system, according to one embodiment; and

FIG. 3 is a diagrammatic view of a portions of an internal combustion engine system, according to one embodiment.

### DETAILED DESCRIPTION

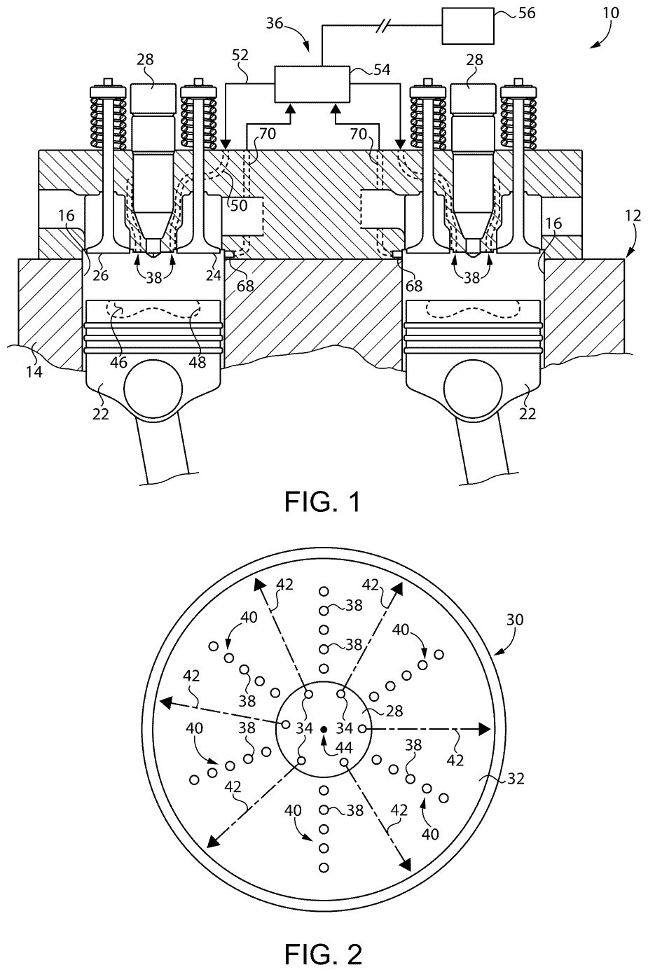

Referring to FIG. 1, there is shown an internal combustion engine system 10, according to one embodiment. Engine system 10 includes an internal combustion engine 12 having a cylinder block 17 with a plurality of cylinders 16 formed therein. A cylinder head 18 is attached to cylinder block 14. A plurality of pistons 22 are positioned in cylinders 16 and each movable in a generally conventional manner between a bottom-dead-center position and a top-dead-center position, typically in a four-stroke engine cycle. Cylinders 16 can include any number, in any suitable arrangement such as an inline pattern, a V-pattern, or still another. Each cylinder 16, hereinafter referred to, at times, in the singular, is associated with one or more intake valves 24 and one or more exhaust valves 26. Intake valve 24 and exhaust valve 26 open and close to provide admission of intake air for combustion, and expelling of exhaust, respectively.

Engine 12 may be compression-ignited, such that pistons 22 are movable to increase a pressure and temperature within the respective cylinder 16 to an autoignition threshold for a directly injected compression-ignition fuel. Suitable fuels can include a diesel fuel, such as a diesel distillate fuel, or lower cetane fuels blended with a cetane enhancer, for example. Engine 12 further includes a plurality of fuel injectors 28 each arranged as direct injectors extending partially into a respective cylinder 16. Fuel injectors 28 may be electronically controlled and hydraulically actuated. Engine system 10 can be applied for any known purpose including operating a driveline in a land vehicle or a marine vessel, or powering a pump, a compressor, or an electrical generator, to name a few examples.

Referring also now to FIG. 2, fuel injector 28 defines a fuel injector center axis 44. Fuel injector 28 is supported in cylinder head 18 and includes a plurality of spray orifices 34 formed therein. Cylinder head 18 and fuel injector 28 may together form a cylinder head assembly 30, illustrating a view of a fire deck 32 of cylinder head 18 in FIG. 2. Spray orifices 34 may be arranged circumferentially around center axis 44 and define a plurality of outgoing fuel spray plume paths 42. Spray orifices 34 can be opened and closed in a generally conventional manner to inject fuel spray jets of pressurized fuel from each respective one thereof. A number of spray orifices 34 may be at least two, and commonly three, four, five, or more. Those skilled in the art will be familiar with internal fuel injector components and operation to selectively inject a fuel for combustion at a desired injection timing.

Engine system 10 also includes a pressurized air supply 36. Cylinder head 18 includes a plurality of air ports 38 distributed circumferentially around fuel injector center axis, fluidly connected to pressurized air supply 36 and arranged offset from outgoing plume paths 42 in cylinder head 18 to admit air jets into cylinder 16 for limiting spray plume-spray plume interaction, as further discussed herein.

The plurality of air ports 38 may include a plurality of air port sets 30 arranged in an alternating pattern with outgoing spray plume paths 42 circumferentially around center axis 44. Each respective one of the plurality of air port sets 40 may include at least two air ports, and typically although not necessarily at spaced radial locations relative to center axis 44. In the illustrated embodiment, air ports 38 of each respective air port set 40 are arranged at least roughly in a line on a radius of a circle centered on fuel injector center axis 44. Each of air ports 38 may be formed by a hole in cylinder head 18. In other instances, nozzles or other mechanical structure attached to and/or within cylinder head 18 might be used. In still other embodiments, rather than individual air ports 38 being arranged in a line, on a radius of a circle as illustrated, air ports 38 could be arranged in clusters having varied circumferential locations and/or varied radial locations around center axis 44. A number of air ports 38 in each respective set 40 as noted above may be at least two. In the illustrated embodiment each air port set 40 includes a total of five air ports 38. Other variations could include three air ports, six air ports, ten air ports, or some other number. A size of holes forming air ports 38 may be larger than a size of spray orifices 34 in some embodiments.

As noted above, engine system 10 further includes piston 22. Piston 22 forms, together with cylinder head 18, cylinder 16. Piston 22 may also form a combustion bowl 46 having a bowl outer wall 48. In an implementation, combustion bowl 46 is reentrant. Plume paths 42 may be oriented so as to target a surface of combustion bowl 46 as further discussed herein.

As also noted above, air ports 38 are arranged to each inject a respective air jet. Embodiments are contemplated where an onboard air compressor provides a feed of pressurized air to air ports 38. In other embodiments, air ports 38 may receive a feed of pressurized air from another cylinder in engine 12. Cylinder head 18 may include a plurality of air admission conduits 50 formed therein. Air admission conduits or air lines 50 may be understood to form at least in part a pressurized air manifold extending to air ports 38. Air admission conduits 50 may connect to a common air supply line 52 in some embodiments.

Also in a practical implementation, engine system 10 may further include an air valve assembly 54 arranged to be positioned fluidly between another cylinder 16 and common air supply line 52. For instance, referring to the leftmost cylinder 16 as a first cylinder in FIG. 1 and the rightmost cylinder as a second cylinder, air valve assembly 54 is arranged fluidly between the second cylinder 16 and common air supply line 52. Each cylinder 16 may further include or be coupled to an air inlet 68 in one of cylinder head 18 or cylinder block 16 that can receive pressurized air from the second cylinder 16 and feed the same through an air line 70 to air valve assembly 54. Air valve assembly 54 thus provides appropriate fluid connections at an appropriate timing to feed air from the second cylinder 16 to the first cylinder 16 for injecting the respective air jets by way of air ports 38. It will also be appreciated that pistons 22 and cylinders 16 will be out of phase of one another during operation. Accordingly, when the first cylinder 16 is injecting fuel, just prior to ignition, the second cylinder 16 will be out of phase and potentially available to supply the feed of pressurized air. After the first cylinder 16 has completed an intake stroke in an engine cycle, prior to completing a compression stroke it can be possible to siphon off pressurized air. Air valve assembly 54 may be electronically controlled by way of an electronic control unit 56 to provide the appropriate fluid connections at the appropriate timings.

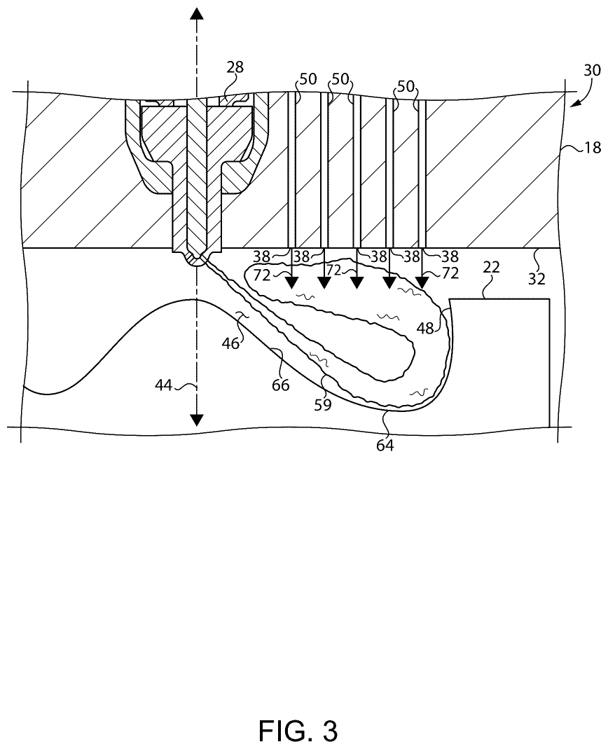

Referring also now to FIG. 3, there are shown features of cylinder head assembly 30 in further detail and illustrating events during an example injection of fuel and injection of air. In FIG. 3, a combusting fuel spray plume 59 is shown as it might appear outgoing from fuel injector 28, passing along a cone slope surface 66 of combustion bowl 46, and impinging upon a bowl floor 64, prior to being directed upwardly and inwardly back towards center axis 44 of fuel injector 28. It will be recalled combustion bowl 46 may be reentrant. Those skilled in the art will appreciate that fuel injector 28 will be operated to inject a fuel spray jet that is compression-ignited to form a combusting fuel plume from each respective one of spray orifices 34. As the spray plumes are directed upwardly and inwardly in cylinder 16 the combusting spray plumes tend to enlarge and continue mixing with air as combustion proceeds. A leading portion of spray plume 59 can thus approach leading portions of adjacent combusting spray plumes from adjacent spray orifices 34, and the respective adjacent combusting spray plumes can contact one another absent mitigation. Without being bound by theory, it is believe the contact of spray plumes with one another can create regions locally rich in fuel that tend to promote soot formation and/or inhibit soot oxidation.

FIG. 3 also illustrates air jets 72 admitted by way of each of air ports 38. It can be appreciated that air ports 38 have a distribution extending radially outward from center axis 44. In an embodiment, air ports 38 may be confined in distribution between an edge of combustion bowl 46, approximately as defined by bowl outer wall 48, and fuel injector 28. “Confined in distribution” means all of air ports 38 may be within the identified range of location. The present disclosure is not limited as such, however. Some embodiments could include air ports that are together biased to a distribution within the identified range of location. The contemplated and illustrated array of air jets 72 can be understood to form a “curtain” or cloud of pressurized air that displaces fuel spray plumes and limits contact between adjacent combusting fuel plumes. The injected air can also provide additional air for combustion. As a result, locally rich pockets of fuel that could in other instances lead to production of soot can be limited or eliminated.

### Industrial Applicability

Referring to the drawings generally, operating engine 12 can include injecting spray jets of fuel into cylinder 16 at an appropriate timing, such as at or close to a top-dead-center position of piston 22 at the end of a compression stroke. The injected fuel can compression-ignite to form combusting fuel spray plumes directed generally into combustion bowl 46. Operating engine 12 can further include redirecting combusting spray plumes of the directly injected fuel upwardly in cylinder 16. As the spray plumes advance back toward center axis 44 and spread outwardly, potentially deflecting off of fire deck 32, air jets 72 can be injected into cylinder 16 at locations offset from the combusting fuel plumes, circumferentially around center axis 44. The air jets 72 can impinge upon, meaning contact, the combusting spray plumes so as to limit spray plume-spray plume interaction in the cylinder and potentially provide additional air for oxidation. In a typical engine cycle the production of soot that might otherwise be observed can thus be limited, and in at least some applications efficiency improved based on the more complete combustion of the injected fuel in each engine cycle.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An engine system comprising:
an engine including a cylinder block having a cylinder formed therein, and a cylinder head attached to the cylinder block;
a fuel injector defining a fuel injector center axis supported in the cylinder head and having a plurality of spray orifices formed therein and defining a plurality of outgoing spray plume paths;
a pressurized air supply; and
the cylinder head including a plurality of air ports distributed circumferentially around the fuel injector center axis, fluidly connected to the pressurized air supply and arranged offset from the plurality of outgoing fuel spray plume paths to admit air jets into the cylinder for limiting spray plume-plume interaction.

2. The engine system of claim 1 wherein the plurality of air ports includes a plurality of air port sets arranged in an alternating pattern with the plurality of outgoing spray plume paths.

3. The engine system of claim 2 wherein each respective one of the plurality of air port sets includes at least two air ports arranged on a radius of a circle centered on the fuel injector center axis.

4. The engine system of claim 2 wherein each of the plurality of air ports is formed by a hole in the cylinder head.

5. The engine system of claim 1 wherein the pressurized air supply includes an air valve assembly, and a plurality of pressurized air lines extending through the cylinder head to the plurality of air ports.

6. The engine system of claim 5 wherein the cylinder block includes at least one other cylinder formed therein, and the air valve assembly is positioned fluidly between the plurality of pressurized air lines and the at least one other cylinder.

7. The engine system of claim 1 further comprising a piston positioned at least partially in the cylinder and having a combustion bowl formed therein, and each of the plurality of outgoing fuel spray plume paths targets a surface of the combustion bowl.

8. The engine system of claim 7 wherein the combustion bowl is reentrant.

9. The engine system of claim 7 wherein the plurality of air ports are biased in distribution to locations radially between the fuel injector and a combustion bowl edge of the piston.

10. A method of operating an engine comprising:
redirecting combusting spray plumes of a directly injected fuel upwardly in a cylinder in an engine;
injecting air jets into the cylinder at locations offset from the combusting spray plumes circumferentially around a center axis of the fuel injector; and
impinging the plurality of air jets upon the plurality of combusting spray plumes so as to limit spray plume-spray plume interaction in the cylinder.

11. The method of claim 10 wherein the redirecting combusting spray plumes includes guiding the combusting spray plumes along a surface of a combustion bowl of a piston.

12. The method of claim 10 wherein the injecting air jets includes injecting the air jets from a plurality of air ports formed in a cylinder head of the engine.

13. The method of claim 12 wherein the plurality of air ports are arranged in a plurality of air port sets in an alternating arrangement with the plurality of combusting spray plumes circumferentially around the center axis.

14. The method of claim 10 further comprising supplying pressurized air for producing the air jets from an out-of-phase cylinder of the engine.

15. The method of claim 10 wherein the fuel includes a compression ignition liquid fuel.

16. The method of claim 15 further comprising aiding oxidation of particulate matter in the combusting spray plumes of the fuel by way of the injected air jets.

17. A cylinder head assembly comprising:
a cylinder head;
a fuel injector supported in the cylinder head defining a fuel injector center axis having a plurality of spray orifices formed therein and defining a plurality of outgoing spray plume paths; and
the cylinder head including a plurality of air ports distributed circumferentially around the fuel injector center axis, and arranged offset from the plurality of outgoing spray plume paths to admit air jets into the cylinder for limiting spray plume-spray plume interaction.

18. The cylinder head assembly of claim 17 wherein the plurality of air ports are arranged in a plurality of air port sets each including at least two air ports at spaced radial locations relative to the center axis of the fuel injector.

19. The cylinder head assembly of claim 17 wherein each of the plurality of air ports is formed by a hole in the cylinder head.

20. The cylinder head assembly of claim 17 wherein the cylinder head forms a pressurized air manifold having a plurality of air lines extending to the plurality of air ports.
